(19) United States
(12) Patent Application Publication
(10) Pub. No.: US 2026/0347116 A1
(43) Pub. Date: Nov. 5, 2026

(54) Bucket Elevator with Directional Fold

(71) Applicant: Rocky Mountain Investor Holdings, Inc., Centennial, CO (US)

(72) Inventors: Wes Cornell, Richmond, TX (US); Marcus C. Dacar, Spearfish, SD (US)

(21) Appl. No.: 19/198,887

(22) Filed: May 5, 2025

(51) Int. Cl. B65G 41/00; B65G 17/12

(52) U.S. Cl. CPC B65G 41/002; B65G 17/126; B65G 41/007; B65G 2201/04

(57) ABSTRACT

A bucket elevator for transporting material has an operational configuration and a transportation configuration. The bucket elevator includes a base and a main body, with the main body having a loading end configured to receive solid material and a discharge end configured to dispense the solid material. The bucket elevator includes a discharge chute connected to the discharge end of the main body and a frame connected to and extending around a periphery of the main body and pivotally connected to the base. A linear actuator is pivotally connected to the base and pivotally connected to the frame, the linear actuator being configured to rotate the frame and the main body between the operational configuration and the transportation configuration upon extension and/or retraction.

### FIELD OF THE DISCLOSURE

The disclosure relates generally to the field of material conveyors. More specifically, the disclosure relates to bucket elevator with a directional fold.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, a bucket elevator for transporting material has an operational configuration and a transportation configuration. The bucket elevator has a main body with a loading end configured to receive solid material and a discharge end configured to dispense the solid material. The bucket elevator includes a discharge chute connected to the discharge end of the main body and a frame connected to and extending around a periphery of the main body. The bucket elevator further includes a base configured to support the frame and the main body, with the base being pivotally connected to the frame by an axle. A linear actuator is pivotally connected to the base and pivotally connected to the frame, with the linear actuator being configured to rotate the frame and the main body between the operational configuration and the transportation configuration. In the operational configuration, the frame is substantially vertical.

According to another embodiment, a bucket elevator has an operational configuration and a transportation configuration. The bucket elevator has a base with a pair of substantially parallel longitudinal base supports connected by at least one lateral base support. The base further includes a pivot support assembly comprising a pivot bracket configured to hold an axle. The pivot support assembly also includes first and second pivot support members connected to the pivot support bracket, with the pivot support members being angularly offset, and an actuator mount bracket connected to a configured to hold a first end of a linear actuator. The bucket elevator also includes a main body comprising a loading end configured to receive material and a discharge end configured to discharge material. The bucket elevator also includes a discharge chute having an inlet pivotally connected to the discharge end of the main body and at least one outlet configured to discharge material therethrough. The bucket elevator also includes a frame extending around a periphery of the main body and configured to hold a second end of the linear actuator. The linear actuator is configured to extend to rotate the bucket elevator into the operational configuration and retract to rotate the bucket elevator into the transportation configuration about the axle. The frame is substantially vertical when the bucket elevator is in the operational configuration, and an uppermost edge of the at least one outlet of the discharge chute rests below an uppermost edge of the inlet of the discharge chute when the bucket elevator is in the transportation configuration.

According to yet another embodiment, a material storage system includes a conveyor with a loading end configured to receive material from an external source and a discharge end configured to discharge the material therefrom. The material storage system includes a bucket elevator has a base with a pair of substantially parallel longitudinal base supports connected by at least one lateral base support. The base further includes a pivot support assembly comprising a pivot bracket configured to hold an axle. The pivot support assembly also includes first and second pivot support members connected to the pivot support bracket, with the pivot support members being angularly offset, and an actuator mount bracket connected to a configured to hold a first end of a linear actuator. The bucket elevator also includes a main body comprising a loading end configured to receive material and a discharge end configured to discharge material. The bucket elevator also includes a discharge chute having an inlet pivotally connected to the discharge end of the main body and at least one outlet configured to discharge material therethrough. The bucket elevator also includes a frame extending around a periphery of the main body and configured to hold a second end of the linear actuator. The linear actuator is configured to extend to rotate the bucket elevator into the operational configuration and retract to rotate the bucket elevator into the transportation configuration about the axle. The material storage system also includes a material storage container configured to receive material from the outlet of the discharge chute.

### BRIEF DESCRIPTION OF THE DRAWINGS

Illustrative embodiments of the disclosure are described in detail below with reference to the attached figures.

FIG. 1 is a front perspective view of a folding bucket elevator in a storage or transportation configuration according to an embodiment of the invention.

FIG. 2 is a side view of the folding bucket elevator of FIG. 1 in a storage or transportation configuration.

FIG. 3 is an enlarged partial side view of the folding conveyor of FIG. 1 in a storage or transportation configuration.

FIG. 4 is a side view of the folding bucket elevator of FIG. 1 in an operational configuration.

FIG. 5 is a front view of the folding bucket elevator of FIG. 1 in an operational configuration.

FIG. 6A is an enlarged, partial perspective view of a locking assembly of the folding bucket elevator of FIG. 1.

FIG. 6B is an enlarged, partial perspective view of a base of the folding bucket elevator of FIG. 1

FIG. 7 is a front perspective view of a discharge end of the folding bucket elevator of FIG. 1 in an operational configuration.

FIG. 8A is a front view of a discharge chute according to an embodiment of the invention.

FIG. 8B is a bottom perspective view of the discharge chute of FIG. 8A.

FIG. 9 is a perspective view of the folding bucket elevator of FIG. 1 in an operational configuration forming part of a material storage system according to an embodiment of the invention.

### DETAILED DESCRIPTION

Various drilling operations for oil and gas wells commonly utilize a hydraulic fracturing process to increase production from the well. During the fracturing process a hydraulic fluid or slurry comprising a mixture of fluids, chemicals, and proppants is mixed and pumped into the well bore. The solid proppants may often be in the form of dry or wet sand, although other proppants may be used where appropriate. Although the fracturing fluid's exact composition may vary depending on the application or nature of the well, generally the fracturing fluid is abrasive in nature. This abrasiveness often requires the fracturing fluid to be mixed or blended near the well site instead of being mixed off-site and pumped to the well. Therefore, the components of the fracturing fluid, such as the solid proppant, must be stored at or near the well site and be easily transportable between the components of a material storage system of the hydraulic fracturing system. The material storage system often includes a conveyor, such as a bucket elevator, for transporting the solid proppant from an intermediate source (e.g., from a transport vehicle) to one or more bulk material storage bins for use in the mixing process. The bucket elevator is preferably transportable from a storage location to a work site and compatible with a plurality of material storage systems. The present invention relates to a folding bucket elevator which has an upright or operational configuration and a folded or transportation configuration which facilitates movement to and from a work site.

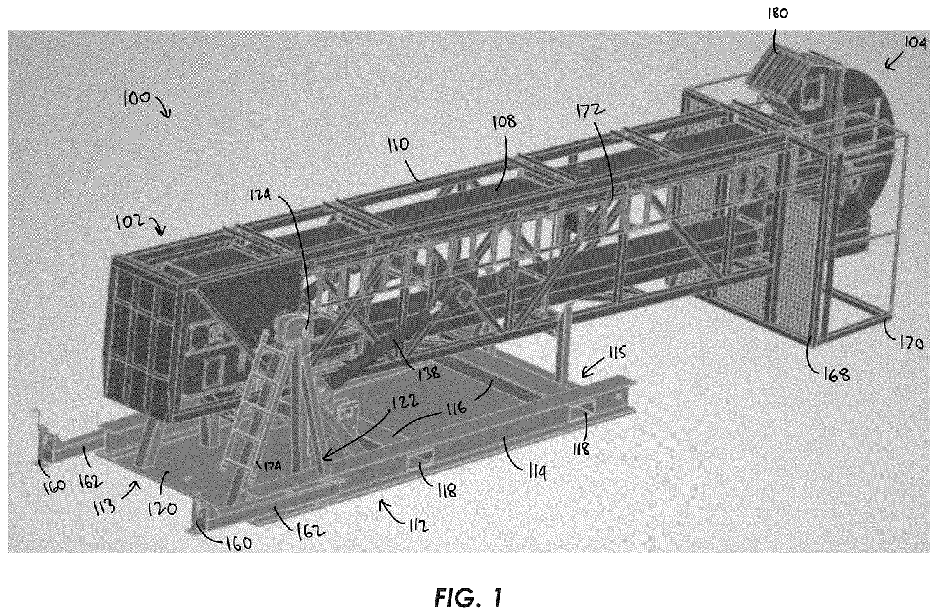

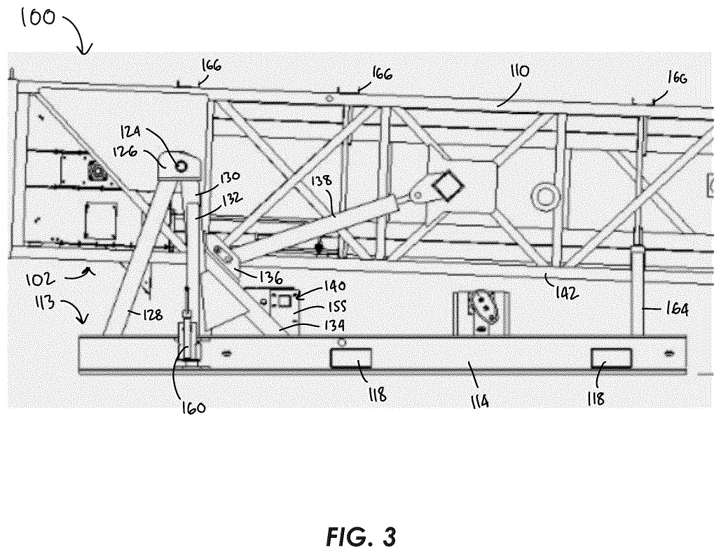

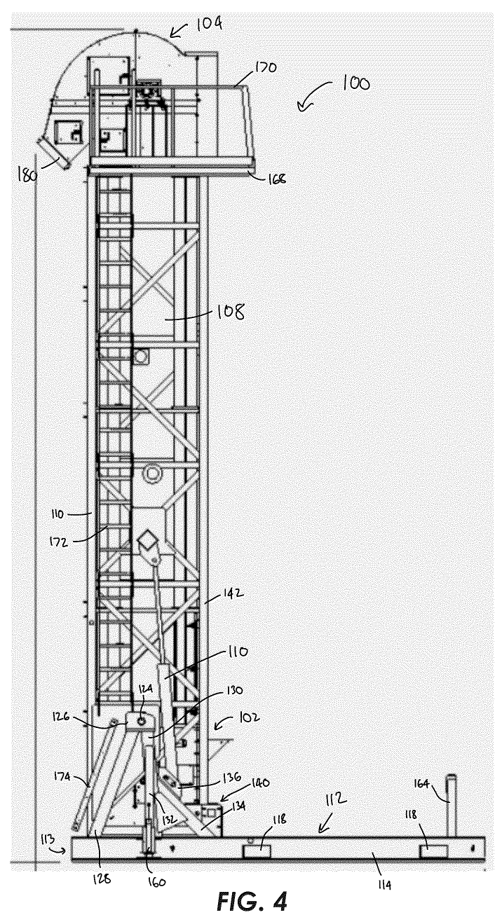

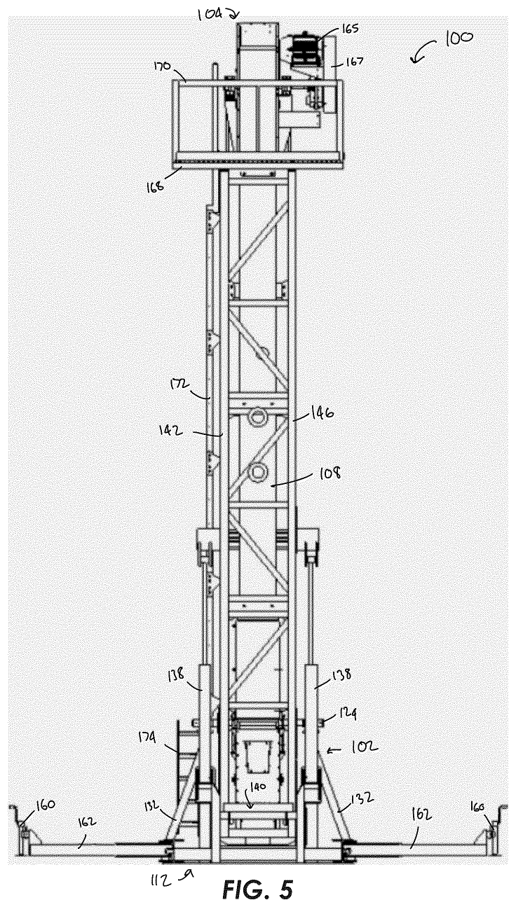

FIG. 1-5 depict an embodiment of a bucket elevator 100 which has a storage or transportation configuration shown in FIG. 1-3 and an operational configuration shown in FIGS. 4 and 5. The bucket elevator 100 may be configured to generally transport solid proppant, such as sand, for hydraulic fracturing applications, although the bucket elevator 100 may be used to transport any type of material now known or later developed. The bucket elevator generally has a proximal or loading end 102 and a distal or discharge end 104. The loading end 102 may be generally configured to receive solid material from an external source (such as a vehicle, a feeding conveyor, or even manually, for example), and the material is moved from the loading end 102 to the discharge end 104 of the bucket elevator 100 and discharged from the discharge end 104 via a discharge chute 106.

The bucket elevator 100 generally has a main body 108 surrounded by a frame 110 which is rigidly secured to the main body 108. The main body 108 is pivotally connected to a base 112, allowing the main body 108 to transition between an upright position in the operational configuration and a lowered or folded position in the transportation configuration.

The base 112 is substantially horizontal and is configured to rest either on the ground at a work site or on the bed of an appropriate vehicle or trailer during transportation. The base 112 has a proximal end 113 and a distal end 115, and in some embodiments the base 112 may form part of a trailer chassis. The base 112, which may be referred to as a skid, has a pair of parallel longitudinal supports or beams 114 which are connected by lateral support members 116. The longitudinal base supports 114 may be formed from steel I-beams or a similar construction, and the lateral base supports 116 may be rectangular steel tubes which are configured to function as fork pockets 118 for a forklift or skid steer. A floor panel 120 may be connected to the longitudinal base supports 114, spanning the area between the longitudinal base supports. The proximal end 113 of the base 112 includes a pair of pivot support assemblies 122, disposed on either side of the main body 108 and frame 110. Each pivot support assembly 122 is rigidly connected to a longitudinal base support 114 and/or the floor panel 120, and is pivotally connected to the frame 110 to allow rotation of the frame 110 and main body 108.

Each pivot support assembly 122 includes a pivot or axle 124 which is held by a pivot bracket 126. The pivot bracket 126 may preferably be substantially U-shaped. In some embodiments, a single axle 124 spans between the pivot support assemblies 122 and through a width of the frame 110. In other embodiments, each pivot support assembly 122 has an axle 124 connected to a side of the frame 110 with the two axles being substantially coaxial. Each pivot bracket 126 is connected to the base by a pair of angular supports 128 and 130, each support 128, 130 being rigidly connected to and extending downward from the pivot bracket 126 and being rigidly connected to the floor panel 120. In some embodiments, the supports 128 and 130 may be connected to a longitudinal base support 114 rather than the floor panel 120. In some embodiments, an additional strut 132 may extend from support 130 to the longitudinal base support 114 to provide structural reinforcement to the pivot support assembly 122.

To facilitate rotation of the bucket elevator 100 between the operational and storage configurations, at least one pivot support assembly 122 includes an actuator mounting member 134 which is connected to the support 130. The actuator mounting member 134 may be, as in the illustrated embodiment, angularly offset and rigidly connected to the support 130 at a first end and rigidly connected to a longitudinal base support 114 and/or the floor panel 120. The actuator mounting member 134 includes an actuator mounting bracket 136 attached to an upper surface. The actuator mounting bracket 136 is configured to hold a first end of a linear actuator 138, with the second end of the linear actuator 138 being connected to the frame 110. The linear actuator 138 is in a contracted state when the bucket elevator 100 is in the transportation configuration, while the actuator 138 is in an extended state when the bucket elevator 100 is in the operational configuration. The linear actuator 138 may be, as in the illustrated embodiment, a hydraulic cylinder. In other embodiments, the actuator 138 may be electrical, pneumatic, manual, or a combination thereof. The actuator may be operated by a switch or user interface provided on the folding bucket elevator 100, may be controlled by an electronic controller on the bucket elevator 100, or may be in data communication with a remote device (e.g., a computer or smartphone), wherein a user may operate the actuator via the remote device. In embodiments where the actuator 138 is controlled by an electronic controller, the controller may raise and/or lower the actuator 138 based upon a characteristic of the bucket elevator 100, for example when the bucket elevator 100 has not been used for a predetermined period of time, upon detection of a part failure, etc., or in response to a user input from an interface either disposed on the conveyor 100 or remotely located. In some embodiments, the bucket elevator 100 may form part of a larger material storage assembly, and the actuator 138 may be raised or lowered based on a characteristic of another element of the storage system, such as whether or not a material storage container has reached a threshold storage capacity.

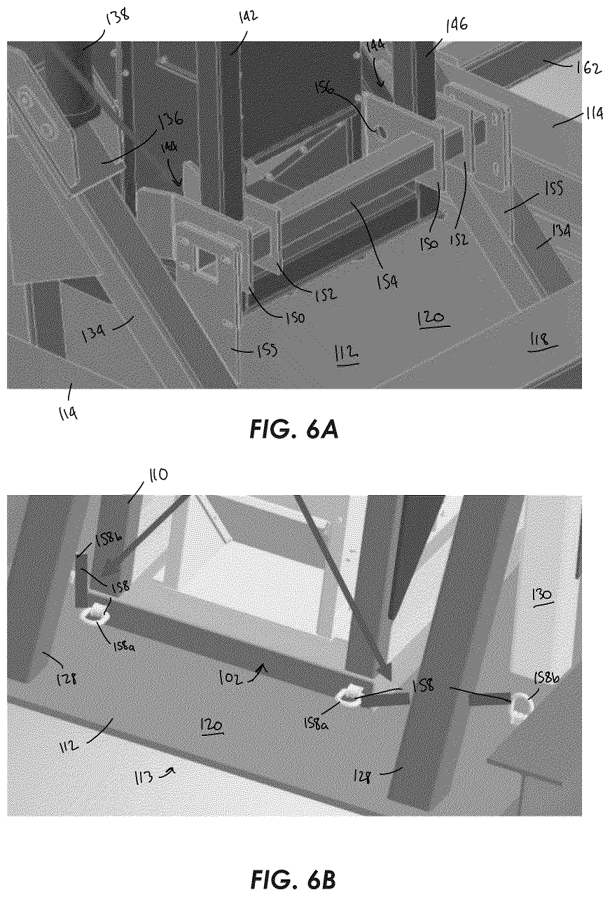

FIG. 6A illustrates a locking assembly 140 for maintaining the bucket elevator 100 in the operational configuration. In the transportation or storage configuration, the loading end 102 of the bucket elevator 100 and the discharge end 104 are disposed on opposite sides of the pivot or axle 124. As the actuator 138 extends and rotates the main body 108 of the bucket elevator 100, the loading end 102 rotates toward the distal end 115 of the base 112 until the frame 110 and main body 108 are in a substantially vertical position. As the frame 110 reaches the substantially vertical position, a longitudinal frame member 142 slidably engages guide slot 144 forming part of the locking assembly 140. Preferably, as in the illustrated embodiment, a second longitudinal frame member 146 simultaneously slidably engages a second guide slot 148 which is substantially parallel to the first guide slot 144. Each guide slot 144, 148 may be formed from a symmetrical pair of plates 150 and 152, with a longitudinal frame member 142 or 146 configured to pass between the plates. Each plate 150, 152 is connected to a cross member 154 which may function as a stop for the frame 110. The cross member may be held at each of its ends by a pair of vertical supports 155 which are rigidly secured to the cross member 154 and to the pivot support assembly 122 and/or the floor panel 120. For each guide slot 144 and 148, at least one plate 150 or 152 includes a through hole 156, and each longitudinal frame member 142 and 146 includes a corresponding hole therein. A locking pin may be inserted into the through hole 156 and into and/or through the hole located on the frame member 142, 146 to lock the frame 110 and main body 108 into the upright or operational configuration. The locking pin is then removed to facilitate rotation of the bucket elevator 100 into the transportation or storage configuration.

As shown in FIG. 6B, the bucket elevator 100 has multiple means for preventing undesired rotation of the elevator 100 when in the operational configuration. Specifically, in addition to the locking mechanism 140, the base 112 and the frame 110 may include complementary eyes or loops 158, to which a restraining means such as a chain, rope, or cable may be connected. In the embodiment shown, a first set of eyes 158a is disposed on a lowermost (with respect to the operational configuration) member of the frame 110, and a second set of eyes 158b is disposed on the floor panel 120 of the base 112. One of skill in the art will appreciate that in other embodiments, the first set of eyes 158a may be located on a different frame member than that shown, without departing from the scope of the invention. Likewise, in other embodiments the second set of eyes 158b may be disposed on the pivot support assembly 122, the longitudinal base supports 114, or another element of the base 112 without departing from the scope of the invention.

The base 112 may include, as in the illustrated embodiment, one or more levelling jacks 160 to provide additional stability when the bucket elevator 100 is in the operational configuration. The jack(s) 160 may be manually-operated (e.g., by a lever or crank), or in some embodiments may be electronically, pneumatically, or hydraulically operated. In some embodiments, the leveling jack(s) 160 may be controlled by an electronic controller, which in some embodiments may be the same electronic controller connected to the actuator 138. In the embodiment shown, e.g., in FIG. 5, the bucket elevator 100 includes a pair of leveling jacks 160, each one pivotally connected to the base 112 at an outward-facing side of a longitudinal base support 114 by a jack support 162. Each jack support 162 may be rotated from a storage configuration, wherein the jack support 162 substantially abuts the longitudinal base support 114, to an operational configuration wherein the jack support 162 is substantially perpendicular to the longitudinal base support 114. The base 112 may include a means for locking or restraining the jack support(s) 162 in the storage configuration.

The distal end 115 of the base 112 may also include a frame support 164 which is configured to hold the frame 110 when the bucket elevator 100 is in the transportation configuration. The frame support 164 may be generally U-shaped or H-shaped, and configured to support the frame 110 such that the discharge end 104 of the main body does not fall below the lowermost edge of the longitudinal base supports 114.

The main body 108 of the bucket elevator 100 may alternately be described as a bucket elevator housing. Enclosed within the bucket elevator housing 108, a plurality of discrete containers (buckets) configured to hold solid material such as sand may be connected along a common chain or drive belt. The chain may be moved by one or more sprockets, such as a drive sprocket, which may be referred to as a head sprocket, at a first end (e.g., the discharge end 102) and an idle, which may be referred to as a boot sprocket, at a second end (e.g., the loading end). The drive sprocket is connected to a motor 165, such as an electric or hydraulic motor, which controls (either directly or through use of a gearbox) the speed of the chain and therefore the discharge rate of material from the discharge chute 106. The motor may be mounted to the frame 110 by a motor mount 167. One or more idle sprockets may be placed within the circumference of the chain between the head sprocket and the boot sprocket to provide additional stability.

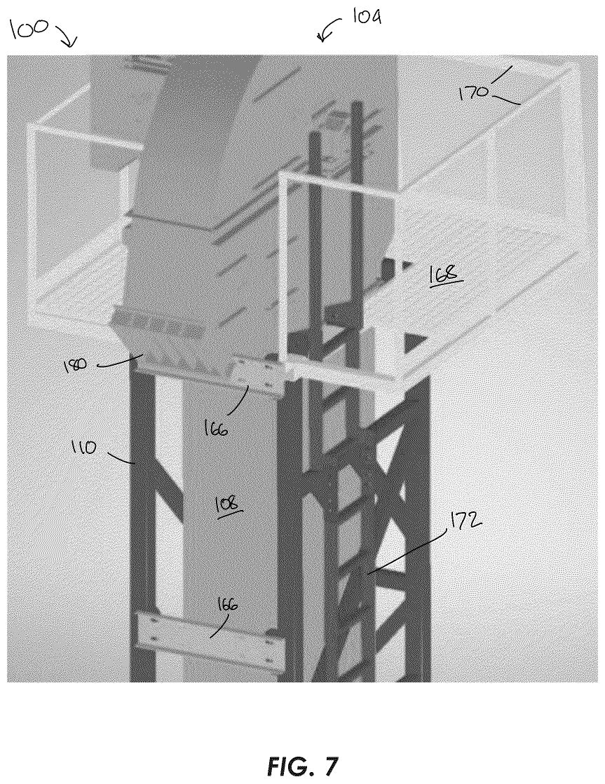

The frame 110 extends around the periphery of the main body 108 and may be a generally rectangular structure as shown in the illustrated embodiment. The frame 110 includes a plurality of trusses along its length to provide structural rigidity. In some embodiments, such as the illustrated embodiment, only three sides (such as the sides parallel to the longitudinal base supports 114 and the side opposite the discharge chute 106) of the frame may have trusses. As shown in FIG. 7, with reference to the operational configuration of the bucket elevator 100, the remaining side of the frame 110 has a plurality of substantially horizontal braces 166 along its height. These braces 166 may be attached to the frame 110 by mechanical fasteners, and may be removed by an operator in order to easily access and/or remove the main body 108 from the frame 110.

Continuing with reference to the operational configuration of the bucket elevator 100, the frame 110 also includes a working platform 168. The working platform 168 is rigidly secured to the frame 110 and is configured to support an operator standing on said platform 168 in order to perform maintenance and generally access the discharge end 104 of the bucket elevator 100 when in the operational configuration. The platform 168 may include one or more handrails 170 extending at least partially, and preferably fully, along its periphery. The platform 168 is accessible via a ladder 172 which is secured to a side of the frame 110 and extends at least from the pivot 124 upwards to a substantially similar height to the handrail 170. As can be seen in FIG. 1, the base 112 may include an additional ladder 174 which an operator may use in conjunction with ladder 172 to access the working platform 168.

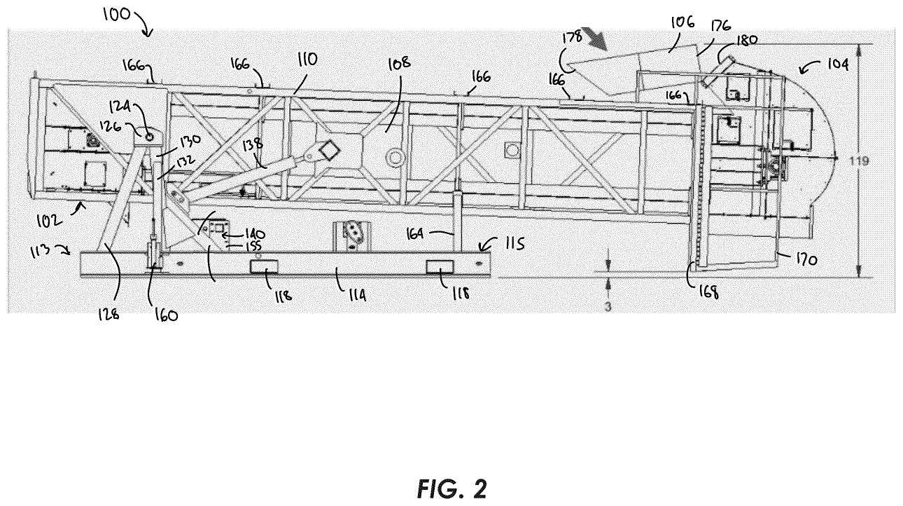

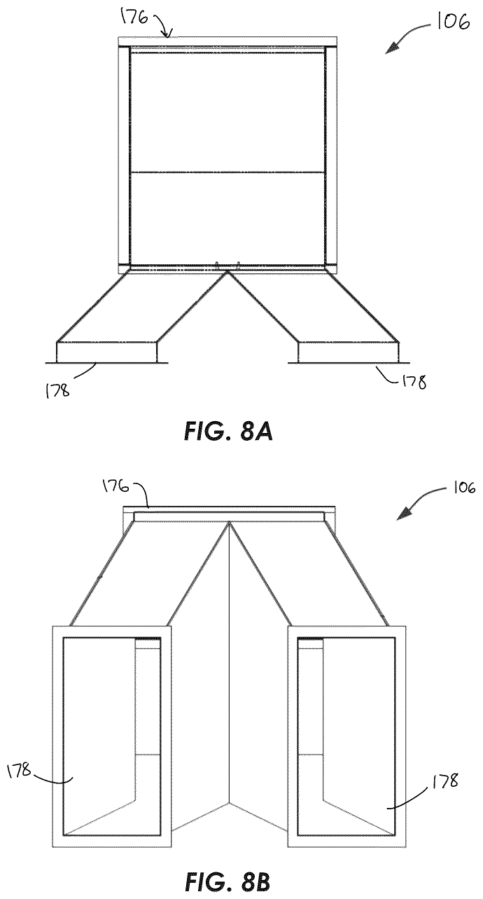

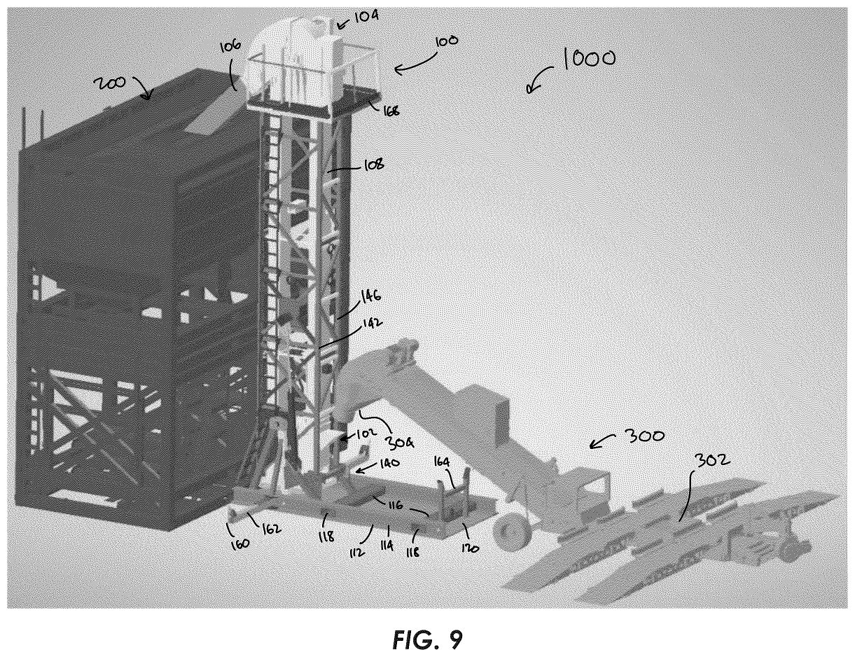

Referring now to FIGS. 8A and 8B, the discharge end 104 of the bucket elevator 100 includes the discharge chute 106. In some embodiments, the discharge chute 106 may have a single inlet 176 and a single outlet 178. In other embodiments, such as the illustrated embodiment, the discharge chute 106 may have a plurality of outlets 178. The discharge chute may be formed integral with the discharge end 104 of the main body 108, or may be selectively detachable therefrom. In some embodiments, the discharge chute 106 may be pivotally connected (e.g., by a hinge) to the discharge outlet 180 of the main body 108, allowing for the discharge chute to be folded downwards with respect to the discharge outlet 180, as seen in FIG. 2. In some embodiments, one or more actuators (e.g., hydraulic cylinders) may be secured between the discharge chute 106 and the main body 108 and may be selectively activated to allow the discharge chute 106 to rotate up and down relative to the discharge outlet 180 of the main body 108. In FIG. 9, the discharge chute 106 is shown rotated into an operational configuration. In FIG. 2, the discharge chute 106 is in a rotated configuration where the inlet 176 is upwardly oriented. Rotating the discharge chute 106 into the rotated configuration as shown in FIG. 2 may allow access to inspect the drive sprocket or other elements of the discharge end 104 of the main body 108.

Turning now to FIG. 9, the bucket elevator 100 may form part of a material transport and storage system 1000. The material storage system 1000 may include the bucket elevator 100, one or more material storage bins 200, and a conveyor 300. The material storage bins 200 may be similar to or substantially the same as material storage containers 172 described in U.S. patent application Ser. No. 18/411,812, titled “Conveyor with Directional Fold” and filed Jan. 12, 2024, the disclosure of which is incorporated herein in its entirety by reference. The conveyor 300 may be a belt-type or similar conveyor now known or later developed which is configured to receive material, namely sand or other solid proppant, and dispense said sand into the loading end 102 of the bucket elevator 100. The conveyor 300 may be a drive-over conveyor, wherein a vehicle (e.g., a truck) drives over a loading area 302 of the conveyor 300 and deposits material onto a belt or similar conveying member that transports the material to the discharge end 304 of the conveyor 300, where the material is then discharged into the bucket elevator 100.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A bucket elevator for transporting material, the bucket elevator having an operational configuration and a transportation configuration and comprising:
a main body having a loading end configured to receive solid material and a discharge end configured to dispense the solid material;
a discharge chute connected to the discharge end of the main body;
a frame connected to and extending around a periphery of the main body;
a base configured to support the frame and the main body, the base being pivotally connected to the frame by an axle; and
at least one linear actuator, each actuator being pivotally connected to the base and pivotally connected to the frame, the at least one linear actuator being configured to rotate the frame and the main body between the operational configuration and the transportation configuration;
wherein in the operational configuration the frame is substantially vertical.

2. The bucket elevator of claim 1, wherein the at least one linear actuator is operable by an electronic controller and the actuator is selected from the group consisting of: a manual crank, a hydraulic cylinder, a pneumatic cylinder, and an electric actuator.

3. The bucket elevator of claim 1, wherein the discharge chute is pivotally connected to the discharge end of the main body, such that in the transportation configuration an inlet of the discharge chute is directed upwards.

4. The bucket elevator of claim 3, wherein the discharge chute is connected to at least one discharge chute linear actuator configured to selectively raise and lower the discharge chute relative to the main body.

5. A material storage system comprising:
the bucket elevator of claim 1;
at least one material storage bin, the material storage bin being configured to receive material from the discharge chute; and
a conveyor having a loading end configured to receive material from an external source and a discharging end configured to dispense said material into the loading end of the bucket elevator.

6. The bucket elevator of claim 1, the base further comprising a locking assembly configured to lock the bucket elevator into the operational configuration.

7. The bucket elevator of claim 6, wherein the locking assembly comprises at least one item selected from a group consisting of:
a locking pin which slidably engages with the frame; and
a first eye disposed on the frame and a second eye disposed on the base, the eyes being connected by one of: a rope, a chain, and a cable.

8. The bucket elevator of claim 1, wherein the base further comprises a pair of receptacles configured to slidably engage with a forklift.

9. The bucket elevator of claim 1, wherein the base forms a part of a trailer chassis.

10. The bucket elevator of claim 1, wherein the frame comprises a plurality of selectively detachable braces.

11. A bucket elevator having an operational configuration and a transportation configuration, the bucket elevator comprising:
a base, comprising:
a pair of substantially parallel longitudinal base supports connected by at least one lateral base support;
a pivot support assembly, comprising:
a pivot bracket configured to hold an axle;
first and second pivot support members connected to the pivot bracket, the pivot support members being angularly offset; and
an actuator mount bracket connected to one of the first and second pivot support members and configured to hold a first end of a linear actuator;
a main body comprising a loading end configured to receive material and a discharge end configured to discharge material;
a discharge chute having an inlet pivotally connected to the discharge end of the main body and at least one outlet configured to discharge material;
a frame extending around a periphery of the main body and configured to hold a second end of the linear actuator;
wherein the linear actuator is configured to extend to rotate the bucket elevator into the operational configuration and retract to rotate the bucket elevator into the transportation configuration about the axle; and
wherein an uppermost edge of the at least one outlet of the discharge chute rests below an uppermost edge of the inlet of the discharge chute when the bucket elevator is in the transportation configuration.

12. The bucket elevator of claim 11, wherein the discharge chute is connected to a discharge chute linear actuator configured to selectively raise and lower the discharge chute relative to the main body, the discharge chute linear actuator being selected from a group consisting of: a hydraulic cylinder, a pneumatic cylinder, and an electric actuator.

13. The bucket elevator of claim 11, wherein the frame further comprises a working platform proximate a periphery of the discharge end of the main body and configured to hold at least one operator, the platform being accessible from a first ladder extending along a length of the frame and a second ladder disposed on the pivot support assembly.

14. The bucket elevator of claim 11, further comprising at least one leveling jack pivotally connected to one of the pair of longitudinal base supports.

15. The bucket elevator of claim 11, wherein each of the longitudinal base support further comprises a pair of receptacles configured to slidably engage with a forklift.

16. A material storage system, comprising:
a conveyor having a loading end configured to receive material from an external source and a discharge end configured to discharge the material therefrom;
a bucket elevator, comprising:
a base, comprising:
a pivot support assembly, comprising
a pivot bracket configured to hold an axle;
first and second pivot support members connected to the pivot bracket, the pivot support members being angularly offset; and
an actuator mount bracket connected to one of the first and second pivot support members and configured to hold a first end of a linear actuator;
a main body comprising a loading end configured to receive material and a discharge end configured to discharge material;
a discharge chute having an inlet pivotally connected to the discharge end of the main body and at least one outlet configured to discharge material;
a frame extending around a periphery of the main body and configured to hold a second end of the linear actuator, the linear actuator being configured to extend to rotate the bucket elevator into an operational configuration and retract to rotate the bucket elevator into a transportation configuration; and
a material storage container configured to receive material from the outlet of the discharge chute.

17. The material storage system of claim 16, wherein the bucket elevator further comprises at least one discharge chute linear actuator which is selectively operable to rotate the discharge chute relative to the discharge outlet of the main body.

18. The material storage system of claim 16, wherein the bucket elevator further comprises a locking assembly disposed on the base, the locking assembly being configured to lock the bucket elevator into the operational configuration.

19. The material storage system of claim 16, wherein the linear actuator is operable by an electronic controller configured to operate the linear actuator based upon a characteristic of the material storage system.

20. The material storage system of claim 19, wherein the characteristic of the material storage system is selected from a group consisting of: a predetermined period of time, detection of a part failure, and a threshold storage capacity.
